(19) United States
(12) Patent Application Publication
(10) Pub. No.: US 2013/0239801 A1
(43) Pub. Date: Sep. 19, 2013

(54) Sorption Dryer

(71) Applicant: Willem Meijer, Zelhelm (NL)

(72) Inventor: Willem Meijer, Zelhelm (NL)

(73) Assignee: OPTIMAIR HOLDING B.V., Tuk (NL)

(21) Appl. No.: 13/697,242

(22) PCT Filed: May 12, 2011
(86) PCT No.: PCT/NL2011/050324

§ 371 Date: Apr. 18, 2013

(30) Foreign Application Priority Data
May 12, 2010 (NL) 2004708

(51) Int. Cl. B01D 53/26

(52) U.S. Cl. CPC B01D 53/26
USPC 95/18; 96/112; 96/111

(57) ABSTRACT

The invention relates to a sorption dryer, comprising: at least one passage through which a gas, particularly air, is fed during use; wherein the or each passage is provided with a sorption material; heating means for heating the sorption material at least locally in order to regenerate the sorption material; a temperature gauge for measuring a temperature representative of the moisture content of the sorption material; and control means for controlling the heating means subject to the measured temperature, wherein the control means are adapted to at least temporarily deactivate the heating means when the measured temperature is higher than a predetermined temperature.

The invention relates to a sorption dryer comprising at least one passage through which a gas, particularly air, is fed during use, wherein the or each passage is provided with a sorption material, and comprising heating means for heating the sorption material at least locally in order to regenerate the sorption material.

Such sorption dryers are used to dry a gas, particularly air. Sorption is understood here to mean both absorption and adsorption. A known sorption dryer comprises a passage provided with a sorption material along which the medium to be dried is guided such that the sorption material absorbs moisture from the medium to be dried. In order to regenerate the sorption material, the sorption material is heated locally by means of heating means such that the sorption material relinquishes the absorbed moisture. The moisture relinquished by the sorption material can then be discharged by guiding a gas, for instance air, along the sorption material, wherein the relinquished moisture is absorbed and discharged by the gas.

A drawback of the known sorption dryer is that heating of the sorption material takes place in uncontrolled manner. It can hereby be the case that the sorption material is heated for an unnecessarily long time, while the sorption material has already relinquished all the absorbed moisture. Conversely, it may also be the case that the sorption material is heated for too short a time, whereby the sorption material retains moisture. This decreases the efficiency of the sorption dryer.

It is an object of the invention to provide a sorption dryer which can be regenerated in efficient and/or simple and/or effective and/or controlled manner.

The sorption dryer of the type stated in the preamble has for this purpose the special feature according to the invention of comprising a temperature gauge for measuring a temperature representative of the moisture content of the sorption material and control means for controlling the heating means subject to the measured temperature, wherein the control means are adapted to at least temporarily deactivate the heating means when the measured temperature is higher than a predetermined temperature.

By measuring a temperature it is easily possible to determine whether the sorption material has already relinquished all the moisture. This is possible for instance by measuring the temperature of the through-fed gas. When gas with a temperature above the temperature of the boiling point of water, which is 100° C. at 1 atmosphere, is carried through the passage, the gas absorbs moisture through evaporation from the sorption material, which can for instance be silica gel. Heat is extracted from the gas in order to heat the moisture, whereby the temperature of the gas drops below that of the boiling point of water. However, when all the moisture has been absorbed from the sorption material the temperature of the gas remains above that of the boiling point of water. When the temperature of the through-fed gas is now measured, it can readily be determined whether all the moisture has been absorbed from the sorption material, since this is the case when the temperature of the gas is higher than that of the boiling point. The heating means can then be controlled on the basis of the measured temperature, for instance by at least reducing or at least temporarily deactivating the heating of the sorption material.

Alternatively, the temperature of the wall can be measured, wherein the temperature is preferably measured in a thickening of the wall. The wall thickening heats with a determined time delay and, by determining empirically at which temperature of the wall thickening the sorption material is dry, the heating means can be controlled in simple manner on the basis of the temperature measured in the wall thickening. The temperature of the wall thickening depends on the starting temperature of the gas to be fed through, just as the time required to regenerate the sorption material depends on the starting temperature of the gas to be fed through, whereby the regeneration of the sorption material can take place efficiently. By measuring the temperature of the wall thickening it is thus possible to determine in simple manner when the sorption material has relinquished all the moisture, on the basis of which the heating means can be controlled, for instance by at least reducing or at least temporarily deactivating the heating of the sorption material.

It is noted that a sorption dryer is also understood to mean a sorption separator. Such a sorption separator can be used to separate substances, wherein optional other sorption materials can be suitable.

The predetermined temperature can for instance be the temperature of the boiling point of water as described above, or the empirically determined temperature of the wall thickening. By temporarily deactivating the heating means when the measured temperature is higher than the predetermined temperature energy can be saved, because it is known that the sorption material has been fully or sufficiently regenerated when the temperature is above the predetermined temperature.

It is noted that at least temporarily deactivating the heating means is understood to mean at least temporarily deactivating the heating means for this specific passage. When there are for instance a number of passages, it is possible for the heating means to be at least temporarily deactivated for one passage, but optionally not being deactivated for the other passage(s), so that the sorption material of the other passage(s) is indeed heated and regenerated.

Because only a temperature need be measured in order to determine whether the sorption material has been fully or sufficiently regenerated, control of the heating means can take place in a simple and/or inexpensive manner.

A sorption dryer of the type stated in the preamble is for instance known from document U.S. Pat. No. B1-7,264,649. In the sorption dryer of U.S. Pat. No. B1-7,264,649 regeneration takes place when the rotation speed of a blower exceeds a predetermined speed. Not measured is whether regeneration has taken place fully or sufficiently, whereby it may occur that the heating means still heat the sorption material when the sorption material has already been fully or sufficiently regenerated. Energy may hereby be wasted.

Another sorption dryer of the type stated in the preamble is for instance known from document US-A1-2006/0091228. In the sorption dryer of US-A1-2006/0091228 whether or not a passage is regenerated takes place on the basis of measurements of temperature, dew point and gas flow, from which combined measurements the humidity of the gas flow is determined and, on the basis of the humidity of the gas flow, whether the sorption material of the associated passage must then be regenerated. In the sorption dryer of US-A1-2006/0091228 multiple, particularly complex measurements are therefore necessary to determine whether or not regeneration is necessary. The sorption dryer according to the invention is therefore distinguished from the sorption dryer of US-A1-2006/0091228 in that it is only necessary to measure a temperature in order to determine whether the regeneration of the sorption material has taken place fully or sufficiently, whereby this determination can take place in simple and/or rapid and/or inexpensive manner without complicated controls and other measurements being necessary.

In a preferred embodiment of the sorption dryer according to the invention the sorption material has a transition temperature, wherein the sorption material is of a type which absorbs moisture at temperatures below the transition point and relinquishes moisture at temperatures above the transition point, wherein the predetermined temperature is equal to the transition temperature.

The transition point preferably lies below the boiling point of water, whereby the sorption material need be heated less than is necessary in the case of usual sorbing materials such as silica gel. The moisture moreover need not be evaporated in order to release it from the sorption material, whereby the heat for evaporation, which requires the most energy by far, is saved. In a sorption separator it can be the case that the sorption materials suitable therefor have their transition points at a different temperature.

It is noted that a transition point is also understood to mean a transition range, wherein the temperature range in which the sorption material transposes between absorbing moisture or relinquishing moisture preferably has a steep gradient.

The sorption material preferably comprises a so-called “lower critical solution temperature polymer”, wherein the transition temperature is the critical solution temperature. The sorption material is preferably chosen from the group consisting of polyoxazoline, poly(dimethylamino ethyl methacrylate) (pDMAEMa) and poly(N-isopropylacrylamide) (pNiPAAm).

A Lower Critical Solution Temperature (LCST) polymer, is a polymer which is soluble in the substances to be separated up to a determined temperature, the critical solution temperature or the transition point, but no longer above this critical solution temperature, so that the absorbed substances are in fact repelled. The transition point usually lies below the boiling point of water, for instance in the order of 60-70° C. By heating the sorption material to above the transition temperature, the sorption material will relinquish the moisture. When a gas with a temperature above the transition temperature is for instance fed through, this gas will absorb moisture from the sorption material and discharge it. The temperature of the gas will however decrease here. When the gas has absorbed all the moisture from the sorption material, the temperature of the gas will remain above the transition temperature. It is hereby possible, by measuring the temperature of the through-fed gas, to determine in simple manner whether the sorption material has been fully or sufficiently regenerated, after which the heating means can be temporarily deactivated. The control means preferably deactivate the heating means temporarily when the measured temperature of the through-fed gas is 4-10° C. above the transition temperature.

In an embodiment of the sorption dryer according to the invention the heating means are adapted to heat the gas during operation such that the sorption material is heated by feeding the gas through the passage during operation.

The sorption material can be heated in simple manner by feeding heated gas through the passages. By measuring the temperature of the gas when the gas has been fed wholly through the passage it is easily possible to determine whether the sorption material has been wholly or sufficiently regenerated, after which the heating means can be controlled. It is noted that it will be apparent that the gas is heated only for regeneration, and that a gas with an ambient temperature is fed through for the purpose of drying a gas.

In an alternative embodiment of the sorption dryer according to the invention the sorption dryer comprises a hygrometer for measuring the humidity of the gas, wherein the control means are adapted to control the heating means subject to the measured humidity.

By measuring the humidity of the gas it is easily possible to determine whether the drying capacity of the sorption material is sufficient. If this is not the case, the sorption material must be regenerated and the heating means are controlled so as to heat the sorption material. The heating means are in this way controlled in simple manner on the basis of the measured humidity of the gas. The humidity of the gas is preferably measured both before being fed through and after being fed through, whereby it is easily possible to determine how much moisture has been absorbed from the gas in order to determine whether the capacity of the sorption material is sufficiently great. On the basis hereof the heating means can be controlled in simple manner.

In an alternative embodiment of the sorption dryer according to the invention the sorption dryer comprises at least two passages separated medium-tightly from each other, wherein the heating means are adapted to heat the sorption material of one of the at least two passages at a time.

By making use of at least two mutually separated passages, wherein the sorption material of one of the passages can be heated at a time, this passage can be regenerated while the other passages can be used to dry the gas. After regeneration of the second passage the heating means can be temporarily deactivated, preferably until the optional hygrometer measures that the drying capacity of the first passage is insufficient. At that moment the heating means are preferably controlled so as to heat the first passage, wherein the second regenerated passage can be used to dry the gas.

In a practical embodiment of the sorption dryer according to the invention the sorption dryer comprises supply means for supplying the gas to one of the at least two passages, wherein the supply means are connected displaceably to the sorption dryer such that the supply means can be displaced between the at least two passages, such that the gas is supplied to one of the at least two passages at a time, this one passage being the passage whose sorption material can be heated.

By supplying the gas in each case to one of the passages whose sorption material can be heated, this passage can be regenerated while the gas for drying can be dried in the other passage(s). Because the supply means are connected displaceably to the sorption dryer, it is easily possible to set which of the at least two passages is regenerated by displacing the supply means and controlling the heating means. A subsequent passage is preferably regenerated when the overall drying capacity of all passages has become insufficient. At that moment the regenerated passage can once again be made available for drying the gas, such that the overall drying capacity of the sorption dryer can once again become sufficient.

In another practical embodiment of the sorption dryer according to the invention the sorption dryer comprises discharge means for discharging the gas from one of the at least two passages, wherein the discharge means are connected displaceably to the sorption dryer such that the discharge means can be displaced between the at least two passages, such that the gas is discharged from one of the at least two passages at a time, this one passage being the passage whose sorption material can be heated.

This practical embodiment has the advantage that the humid gas which has regenerated one of the at least two passages can be discharged in simple manner, for instance to the outside.

In a practical embodiment of the sorption dryer according to the invention the sorption dryer comprises displacing means for displacing the supply means and/or discharge means between the at least two passages, wherein the control means are adapted to control the displacing means subject to the measured temperature and/or the measured humidity.

The supply means can be moved readily between the different passages using such displacing means.

The invention further relates to a method for regenerating a sorption dryer, comprising of:

feeding a gas, particularly air, through a passage of the sorption dryer;

at least partially heating a sorption material of the sorption dryer by means of heating means for the purpose of regenerating the sorption material;

measuring a temperature representative of the moisture content of the sorption material; and

controlling the heating means subject to the measured temperature such that the heating means are at least temporarily deactivated when the measured temperature is higher than a predetermined temperature.

As described above, the gas can be dried in simple manner using such a method, wherein the sorption material can be easily regenerated and the regeneration can be stopped when the measured temperature is higher than a predetermined temperature, or when the regeneration of the sorption material has taken place fully or sufficiently.

The invention will be further elucidated with reference to figures shown in a drawing, in which:

FIG. 1 is a perspective view of a sorption dryer according to an embodiment of the invention;

FIG. 2 is a detail view of a passage of the sorption dryer of FIG. 1;

FIG. 3 is a perspective view of the rear side of the sorption dryer of FIG. 1; and

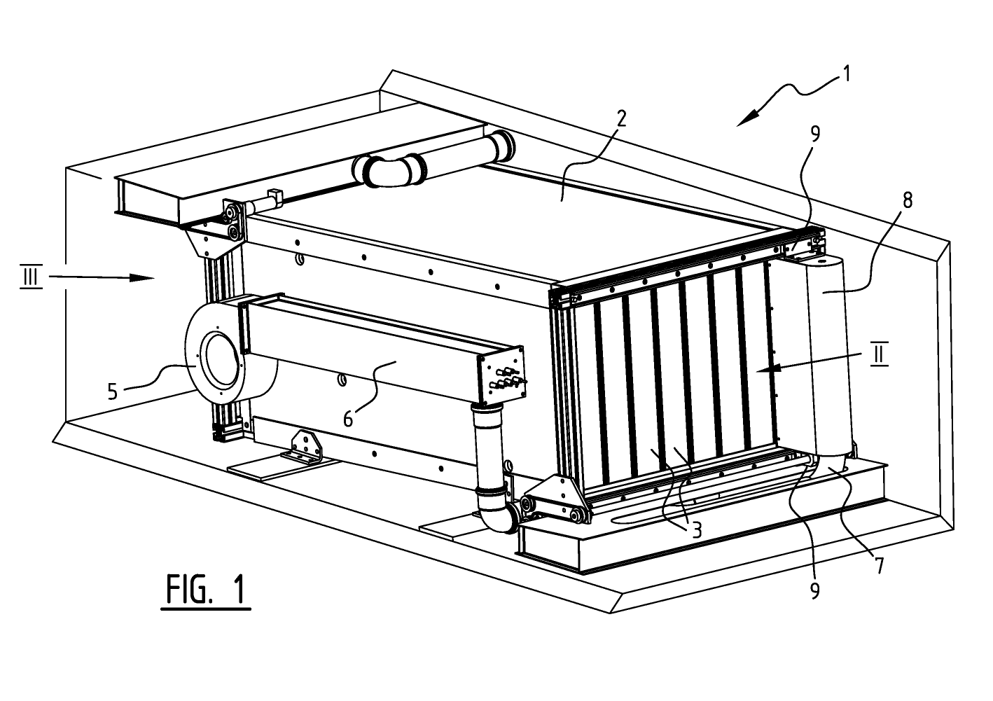

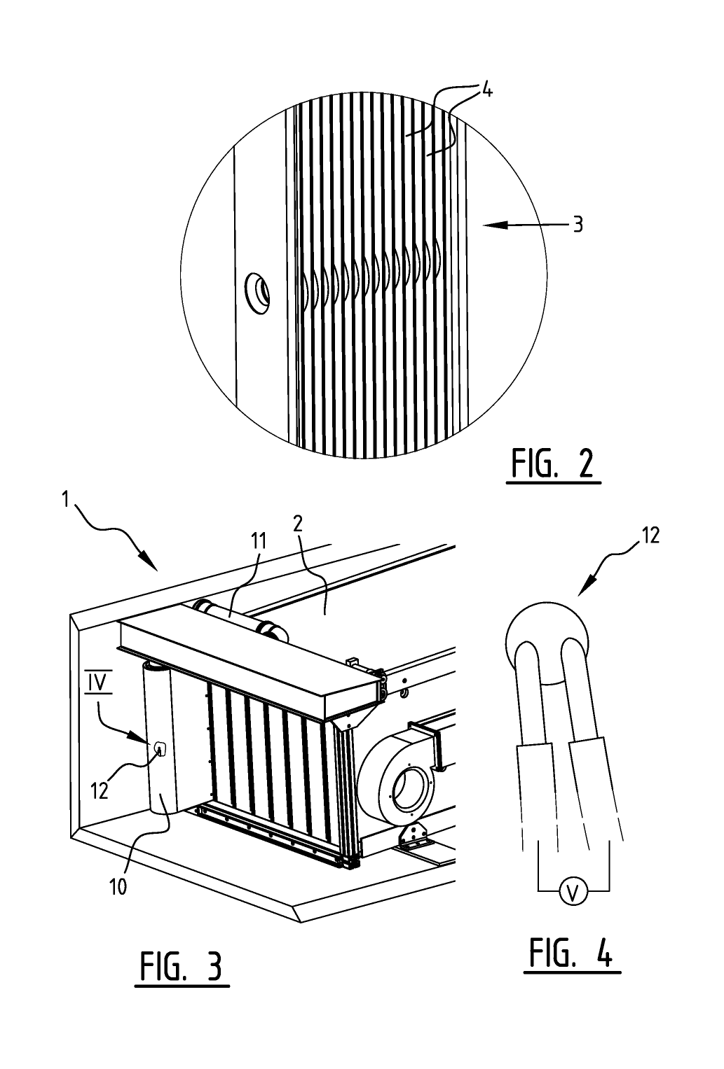

FIG. 4 shows a temperature gauge of FIG. 3 in detail.

FIG. 1 shows a sorption dryer 1 comprising a housing 2 with a number of passages 3 in the form of releasable cassettes, through which a gas, particularly air, is fed during use. Each passage 3 comprises a number of plates 4 provided with a sorption material, this sorption material comprising a “lower critical solution temperature polymer” (see FIG. 2).

Sorption dryer 1 further comprises a fan 5 for drawing in the air and heating means 6 for heating the indrawn air. Heating means 6 are connected by means of a flexible supply hose 7 to supply means 8 in the form of a distributor, supply means 8 being connected displaceably to sorption dryer 1 by means of guide means 9 such that supply means 8 can be displaced between the different passages 3.

FIG. 3 shows the rear side of sorption dryer 1, which indicates that on the rear side of sorption dryer 1 are arranged discharge means 10 which are likewise connected displaceably to sorption dryer 1 such that discharge means 10 can be displaced between the different passages 3. Discharge means 10 are connected via a flexible discharge hose 11 to for instance the outside air for the purpose of discharging humid air.

During operation the supply means 8 and discharge means 10 are usually connected to the same passage 3 such that the air is supplied on the one side of sorption dryer 1 and the air is discharged on the other side.

Sorption dryer 1 further comprises a thermocouple 12 for measuring the temperature of the through-fed air, this thermocouple being arranged in discharge means 10 (see FIGS. 3 and 4).

During operation of sorption dryer 1 the air for drying is fed through passages 3 such that the sorption material in passages 3 absorbs moisture from the air to be dried. The sorption material becomes saturated by absorbing the moisture from the air. However, because the sorption material is an LCST polymer, the sorption material will relinquish moisture when the temperature is higher than a determined, critical solution temperature. The sorption material can therefore be regenerated by increasing the temperature thereof above this critical temperature. The critical temperature usually lies below the boiling point of water, for instance in the order of magnitude of 60-70° C. The sorption dryer 1 according to the invention makes use hereof.

In order to regenerate the sorption material of passages 3 air is drawn in by fan 5 and heated by heating means 6. The air is then guided via flexible hose 7 and supply means 8 through one of the passages 3. Because the air is heated, the temperature of the sorption material will rise above the critical temperature. The warm air will hereby absorb moisture from the sorption material, whereby the sorption material is regenerated. On the rear side of sorption dryer 1 the humid air is discharged to the outside by means of discharge means 10 and flexible hose 11. Also situated in discharge means 10 is a thermocouple 12 which measures the temperature of the through-fed air. While the air is being fed through passage 3 and moisture is absorbed from the sorption material the temperature of the through-fed air will fall below the critical temperature. When the air has absorbed all the moisture from the sorption material, this temperature will however not fall. It will hereby be apparent that, when the temperature of the through-fed air lies below the temperature of the critical point, the air is still absorbing moisture during throughfeed and the sorption material is therefore not yet fully or sufficiently regenerated. When the temperature remains above that of the critical point, all the moisture has been absorbed and the sorption material is wholly or sufficiently regenerated. Measuring the temperature of the through-fed air is therefore a measure of the moisture content of the sorption material and, depending on this measured temperature, the heating means can be activated or deactivated, or supply means 8 and discharge means 10 can be controlled so as to be displaced to a subsequent passage 3.

In sorption dryer 1 heated air is therefore blown through one of the passages 3 at a time in order to regenerate this passage 3. The other passages 3 are at that moment able to absorb moisture from the air to be dried. Sorption dryer 1 preferably comprises a hygrometer (not shown) for measuring the humidity of the gas for drying fed through the other passages 3. When the humidity of this air is too high, it is apparent that the sorption material of the other passages 3 must be regenerated, since the combined drying capacity is not sufficient. Supply means 8 and discharge means 10 are controlled at that moment so as to displace to a subsequent passage 3 in order to regenerate this passage 3. The passage 3 just regenerated is able to dry air, whereby the overall drying capacity of sorption dryer 1 increases. When the hygrometer indicates that the drying capacity of sorption dryer 1 is sufficient and the thermocouple indicates that the regenerated passage 3 has been fully or sufficiently regenerated, heating means 5 can be temporarily deactivated in order to save energy. With the sorption dryer 1 according to the invention air can therefore be dried and sorption material regenerated very efficiently.

It is noted that the invention is not limited to the above discussed exemplary embodiment, but also extends to other variants falling within the scope of the appended claims.

1. Sorption dryer, comprising:
at least one passage through which a gas, particularly air, is fed during use;
wherein the or each passage is provided with a sorption material; and
heating means for heating the sorption material at least locally in order to regenerate the sorption material;
characterized by
a temperature gauge for measuring a temperature representative of the moisture content of the sorption material; and
control means for controlling the heating means subject to the measured temperature, wherein the control means are adapted to at least temporarily deactivate the heating means when the measured temperature is higher than a predetermined temperature.

2. Sorption dryer as claimed in claim 1, wherein the sorption material has a transition temperature, and wherein the sorption material is of a type which absorbs moisture at temperatures below the transition point and relinquishes moisture at temperatures above the transition point, wherein the predetermined temperature is equal to the transition temperature.

3. Sorption dryer as claimed in claim 1, wherein the sorption material comprises a “lower critical solution temperature polymer”, wherein the transition temperature is the critical solution temperature.

4. Sorption dryer as claimed in claim 1, wherein the heating means are adapted to heat the gas during operation such that the sorption material is heated by feeding the gas through the passage during operation.

5. Sorption dryer as claimed in claim 1, comprising a hygrometer for measuring the humidity of the gas, wherein the control means are adapted to control the heating means subject to the measured humidity.

6. Sorption dryer as claimed in claim 1, comprising at least two passages separated medium-tightly from each other, wherein the heating means are adapted to heat the sorption material of one of the at least two passages at a time.

7. Sorption dryer as claimed in claim 6, comprising supply means for supplying the gas to one of the at least two passages, wherein the supply means are connected displaceably to the sorption dryer such that the supply means can be displaced between the at least two passages, such that the gas is supplied to one of the at least two passages at a time, this one passage being the passage whose sorption material can be heated.

8. Sorption dryer as claimed in claim 6, comprising discharge means for discharging the gas from one of the at least two passages, wherein the discharge means are connected displaceably to the sorption dryer such that the discharge means can be displaced between the at least two passages, such that the gas is discharged from one of the at least two passages at a time, this one passage being the passage whose sorption material can be heated.

9. Sorption dryer as claimed in claim 7, comprising displacing means for displacing the supply means and/or discharge means between the at least two passages, wherein the control means are adapted to control the displacing means subject to the measured temperature and/or the measured humidity.

10. Method for regenerating a sorption dryer, comprising of:
feeding a gas, particularly air, through a passage of the sorption dryer;
at least partially heating a sorption material of the sorption dryer by means of heating means for the purpose of regenerating the sorption material;
characterized by
measuring a temperature representative of the moisture content of the sorption material; and
controlling the heating means subject to the measured temperature such that the heating means are at least temporarily deactivated when the measured temperature is higher than a predetermined temperature.
